(19) United States
(12) Patent Application Publication
(10) Pub. No.: US 2026/0116318 A1
(43) Pub. Date: Apr. 30, 2026

(54) DIGITAL LICENSE PLATE AND SYSTEM WITH EXPEDITED ACQUISITION AND DISPLAY OF ALERT NOTIFICATIONS

(71) Applicant: Kipp A. Loving, Garden City, ID (US)

(72) Inventor: Kipp A. Loving, Garden City, ID (US)

(21) Appl. No.: 19/370,390

(22) Filed: Oct. 27, 2025

Related U.S. Application Data
(60) Provisional application No. 63/712,797, filed on Oct. 28, 2024.

(51) Int. Cl. B60R 13/10; G09F 9/30; G09F 19/22; H04W 4/44; H04W 4/80; H04W 4/90

(52) U.S. Cl. CPC B60R 13/10; G09F 9/30; G09F 19/22; H04W 4/44; H04W 4/80; H04W 4/90

(57) ABSTRACT

A digital license plate includes a display, a cellular modem, a chipset coupled to the cellular modem, and a processor coupled to the cellular modem and the display. The display displays notices based on notification commands. The cellular modem communicates with a server through a communications network to receive notification commands from the server. The chipset communicates with a user device through a mesh network, and in response to receipt of an alert notice from the user device through the mesh network, causes the cellular modem to establish a communication session with the server through the communications network during which the cellular modem receives an alert notification command associated with the alert notice. Establishment of the communication session occurs within an expediated communication time window. The processor processes the alert notification command received through the cellular modem, and causes the display to display a notice.

### CROSS-REFERENCE TO RELATED APPLICATIONS

This application claims the benefit of U.S. Provisional Application Ser. No. 63/712,797, entitled “Digital License Plate and System With Expedited Acquisition and Display of Alert Notifications” and filed on Oct. 28, 2024, which is expressly incorporated by reference herein in its entirety.

### TECHNICAL FIELD

The present disclosure relates generally to digital license plates, and more particularly, to a digital license plate and system with expedited processing, e.g., acquisition and display, of alert notifications.

### BACKGROUND

The digital license plate comes in two flavors with one being a battery operated plate, and the other being a plate that requires constant power. Both plates have a cellular modem embedded on the internal board. The wired plate also has a GPS radio. Although there are several features of a digital license plate, one particular feature stands out with customers. If your car is reported stolen, a “stolen” message is displayed on the license plate to assist law enforcement in the recovery of the vehicle. In addition to the digital plate “stolen” feature, other messaging options can include, amber alerts, emergency weather advisories and silver alerts, among others that could be authorized by individual state department of motor vehicles. Out of the two plates the battery plate is by far the most popular plate on the roadway.

Battery life is a concern and currently the battery will last about 3-7 years depending on several factors which include plate owner/users interaction. Digital license plates preserve battery life by limiting the connectivity of the internal cellular modem, which limits the ability for a notification of a stolen car to reach the plate if the car is reported stolen. Depending on the settings by the user the internal cellular modem will check in approximately every 24 hours to 7 days for new notifications, messages, firmware updates, or software updates. Also note that if the owner of the vehicle has the app running on their device and is within Bluetooth range it can also sometimes trigger an update. If a car is stolen it is undesirable to wait up to 24 hours to 7 days to be able to push the “stolen” message down to the digital license plate display. This makes the stolen message associated with the digital license plate more of a novelty item than an actual tool to help recover the stolen car.

### SUMMARY

A digital license plate includes a display, a cellular modem, a chipset coupled to the cellular modem, and a processor coupled to the cellular modem and the display. The display is configured to display notices based on notification commands. The cellular modem is configured to communicate with a server through a communications network to receive notification commands from the server. The chipset is configured to communicate with a user device through a mesh network, and responsive to receipt of an alert notice from the user device through the mesh network, causes the cellular modem to establish a communication session with the server through the communications network, during which the cellular modem receives an alert notification command associated with the alert notice. The establishment of the communication session occurs within an expediated communication time window. The processor is configured to process the alert notification command received through the cellular modem, and to cause the display to display a notice provided with the alert notification command.

A method of expediting operation of a digital license plate includes receiving, at the digital license plate, an alert notice transmitted by a user device through a mesh network; and responsive to receipt of the alert notice, causing a cellular modem of the digital license plate to establish a communication session with a server through a communications network. The method further includes receiving, during the communication session and through the cellular modem of the digital license plate, an alert notification command transmitted by the server; processing, at the digital license plate, the alert notification command; and displaying, at the digital license plate, a notice provided by the alert notification command.

An alert notification network includes one or more servers and a mesh network comprising a plurality of nodes in the form of digital license plates. The digital license plates are configured to exchange authorized alert notices through the network. One or more of the digital license plates in the alert notification network includes a display, a cellular modem, a chipset coupled to the cellular modem, and a processor coupled to the cellular modem and the display. The display is configured to display notices based on notification commands. The cellular modem is configured to communicate with a server through a communications network to receive notification commands from the server. The chipset is configured to communicate with a user device through the mesh network, and responsive to receipt of an alert notice from the user device through the mesh network, causes the cellular modem to establish a communication session with a server through the communications network, during which the cellular modem receives an alert notification command associated with the alert notice. The establishment of the communication session occurs within an expediated communication time window. The processor is configured to process the alert notification command received through the cellular modem, and to cause the display to display a notice provided with the alert notification command.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a block diagram of a digital license plate system that enables unscheduled, expedited processing of alert notifications.

FIG. 2 includes examples of alert notifications displayed by the system of FIG. 1 on an expedited basis.

FIG. 3 is a flowchart of a method enabled by the digital license plate system of FIG. 1.

### DETAILED DESCRIPTION

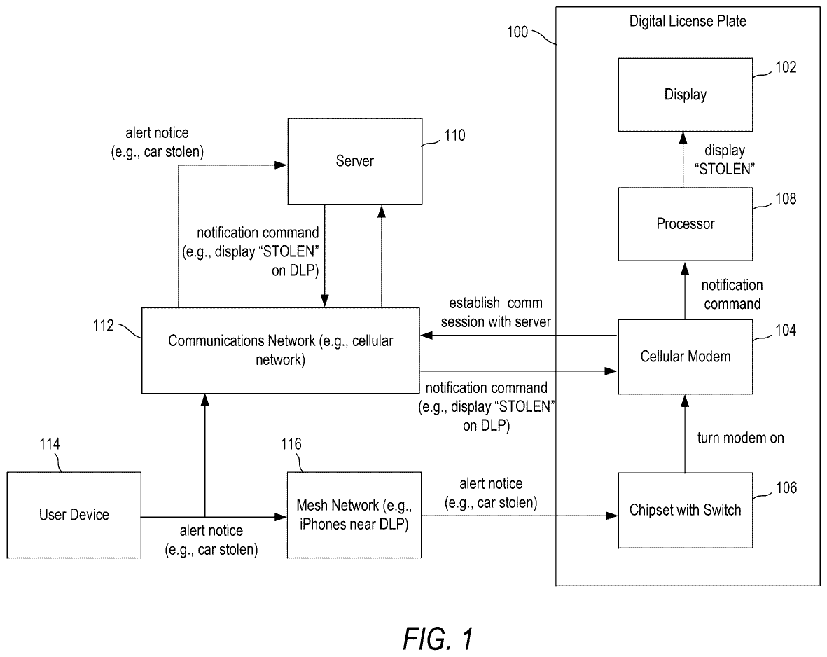

With reference to FIG. 1, a digital license plate (DLP) 100 disclosed herein includes a display 102, a cellular modem 104, a chipset 106 that is coupled to the cellular modem 104, and a processor 108 that is coupled to the cellular modem 104 and the display 102. The display 102 is configured to display notices based on notification commands that are received by and processed by the processor 108.

The cellular modem 104 is configured to establish communication sessions with a server 110 through a communications network 112. In some embodiments the cellular modem 104 comprises a low-power LTE Cat-M1/NB-IoT module such as the u-blox SARA-R410M. In some embodiments the communications network 112 is a cellular network. During these communication sessions one or more notification commands can be transmitted by the server 110 to the cellular modem 104. The notification commands include messages that are subsequently displayed on the display 102. Secure communication between the cellular modem 104 and the server 110 is maintained through hardware-based AES encryption, firmware signing, and optional use of a secure element such as the STSAFE-A110 for key management and authentication.

In some cases, communication sessions between the cellular modem 104 and the server 110 are scheduled sessions that occurs periodically based on a programmed schedule, e.g., every 24 hours to 7 days. Scheduled communication sessions are initiated by the processor 108. To this end, the processor 108 is configured to periodically cause the cellular modem 104 to initiate a scheduled communication session to obtain non-alert notification commands from the server 110. The processor 108 is configured to process the non-alert notification command received by the cellular modem 104, and to cause the display 102 to display the notice that is associated with the non-alert notification command. Generally, scheduled communication session relate to system maintenance, firmware/software updates, diagnostic transmissions from the digital license plate, registration renewals, and related topic. Examples of notices provided by non-alert notification commands include REGISTRATION RENEWAL DUE and SOFTWARE IS UP TO DATE.

In some cases, communication sessions between the cellular modem 104 and the server 110 are unscheduled sessions that occur separate from and independent of scheduled communication sessions. As described further below, these unscheduled communication sessions, also referred to herein as expedited communication sessions, are initiated by the chipset 106 in response to the receipt of an alert notice from a user device 114.

The chipset 106 is configured to communicate with a user device 114 through a mesh network 116 to receive an alert notice (e.g., my car was stolen) transmitted from the user device. In some embodiments, the alert notice is a verified alert notice, meaning the alert notice is one that has been verified through a law-enforcement or backend authentication process. This way, when an owner reports a vehicle stolen through the app, the alert notice is not pushed to the chipset 106 plate until the stolen-vehicle report is verified with law enforcement. In some embodiments the chipset 106 comprises a Bluetooth Low Energy 5 transceiver such as the u-blox NINA-B30 incorporating the Nordic nRF52840 System-on-Chip (SoC).

The chipset 106 communicates with a user device 114 through the mesh network 116 through encrypted, rotating identifiers, compatible with frameworks such as Apple Find My or Google's Find Hub network. The mesh network 116 may be a network similar to that which enables Apple AirTags or Apple's Find My Phone feature or Google Tiles. For example, the mesh network 116 may include a crowd-source network of user devices having components that can relay data, e.g., alert notices, to a target device. The crowd-source network of user devices and components can include, for example, the cellular modem 104 of the digital license plate 100, the cellular modems of other digital license plates, the chipset 106 of the digital license plate 100, the chipsets of other digital license plates, and communication components, e.g., cellular modems, Bluetooth transceivers, Wi-Fi transceivers, of other mobile devices. The alert notice transmitted by a user device 114 is also sent to the server 110 through the communications network 112. The server 110 processes the alert notice to determine the content of the notification command that the server will transmit to the digital license plate 100.

Returning to the chipset 106 of the digital license plate 100, the alert notice transmitted by the user device 114 to the chipset 106 through the mesh network 116 triggers an expedited communication session between the digital license plate 100 and the server 110 through the communications network 112. To this end, in response to receipt of an alert notice, the chipset 106 turns on the cellular modem 104. In some embodiments, the chipset 106 is directly connected to the cellular modem 104 and includes a switch that switches the cellular modem 104 on. In some embodiments, the chipset 106 turns the cellular modem 104 on through a connection (not shown) with the processor 108. In the later configuration, the chipset 106 and the processor 108 cooperate in an ultra-low-power sleep mode, activating the cellular modem 104 only when a verified alert or system event occurs. This design extends operational battery life to approximately five years or more.

After being switched on, the cellular modem 104 initiates an expedited communication session with the server 110 through the communications network 112. During this expedited communication session, the server 110 sends an alert notification command to the cellular modem 104 through the communications network 112. As noted above, the alert notice transmitted by a user device 114 is also sent to the server 110 through the communications network 112, and the server 110 processes the alert notice to determine the content of the notification command that the server will transmit to the digital license plate 100.

The time it takes to establish an unscheduled communication session varies depending on the capability of the server 110 and the mesh network 116 in the geographical location of the digital license plate 100. The server 110 may employ a scalable, cloud-based message-broker architecture with queue prioritization to manage multiple digital license plates 100 across jurisdictions. In some embodiments, the server 110 in conjunction with other network components enable user devices 114 to establish unscheduled communication sessions within an expedited time window. The efficiency in establishing these communication session ensures timely display of urgent notifications. Typically, the time to establish an unscheduled or expedited communication session is in the range 1 to 45 minutes. This time is referred to herein as an expedited communication time window.

Note, as used herein “establishment of an expedited communication session” means the time it takes for the cellular modem 104 of a user's DLP 110 to establish communication with a server 110. With reference to FIG. 1, this includes the time it takes to complete the following sequence: a user pushes an alert notice of a user device 114, a mesh network 116 receives the alert notice, the alert notice is received by the chipset 106 of the digital license plate 100, the chipset turns the cellular modem 104 of the DLP on, and the cellular modem connects with the server 110 through the communication network 112. After an expedited communication session is established, communication between the server 110 and cellular modem 104, including the receipt of a notification command at the cellular modem, occurs during the established communication session and can be completed in a matter of seconds.

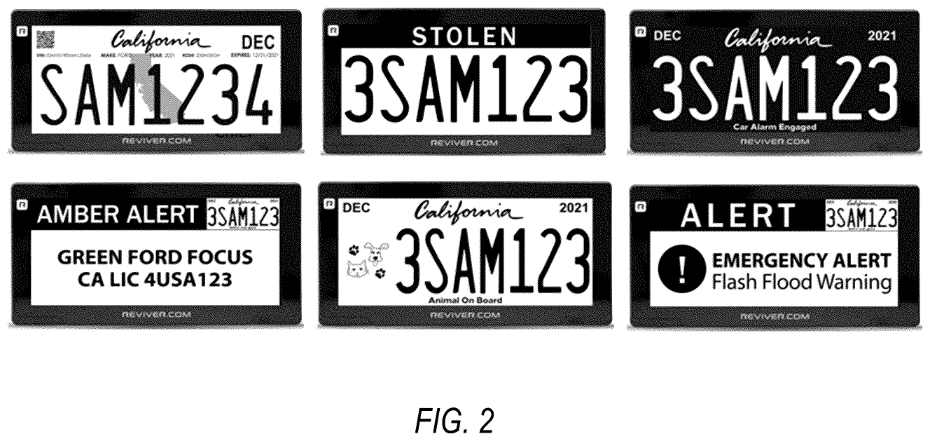

Returning to the cellular modem 104 of the digital license plate 100, the cellular modem 104 provides the notification command to the processor 108 of the digital license plate 100. The processor 108 is configured to process the alert notification command received through the cellular modem 104 and to cause the display 102 to immediately display a notice that is associated with the alert notice. For example, if the alert notice transmitted by the user device 114 is “my car was stolen” the alert notification command sent by the server 110 and processed by the processor may cause the display 102 to display “STOLEN”. Examples of alert displays are shown in FIG. 2.

In response to receipt of an alert notice, the crowd-source network of user devices forming the mesh network 116 can determine the location of the stolen car. Such location determination can be enabled using technology like Apple's AirTag or Find My Phone technology. As noted above, the crowd-source network of user devices can include, for example, the cellular modem 104 of the digital license plate 100, the cellular modems of other digital license plates, and the communication components and modalities, e.g., cellular modems, Bluetooth, Wi-Fi, of mobile phones.

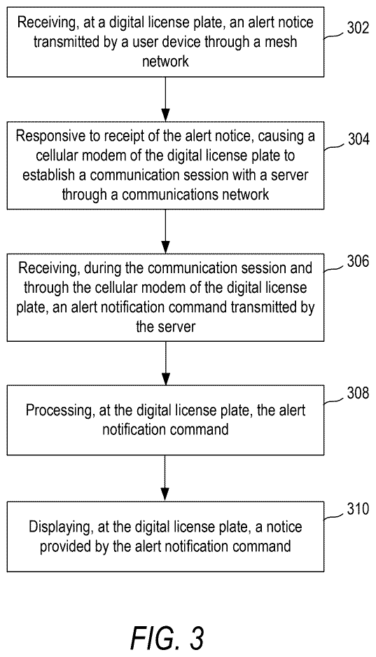

FIG. 3 is a flowchart of a method expediting operation of a digital license plate. The method can be enabled by the digital license plate system of FIG. 1.

At block 302, an alert notice transmitted by a user device 114 is received at the digital license plate 100 through a mesh network 116. The user device 114 can be a mobile phone of an owner of the digital license plate 100 and the alert notice can be on that indicates the owner's car was stolen.

At block 304, in response to the receipt of the alert notice, a cellular modem 104 of the digital license plate 100 is turned on and an unscheduled communication session is established by the cellular modem 104 with a server 110 through a communications network 112. The communication network 112 can be a cellular network.

At block 306, during the unscheduled communication session the cellular modem 104 of the digital license plate 100 receives an alert notification command. The alert notification command is transmitted by the server 110 through the communications network 112.

At block 308, the alert notification command is processed by a processor 108 of the digital license plate 100 to determine a notice to display. In some embodiments the alert notification command is configured to cause the digital license plate 100 to display a notice based on the alert notice transmitted by the user device 114. For example, in the case of an alert notice that the user's car was stolen, the alert notification command can cause the digital license plate 100 to display STOLEN.

At block 310, the notice provided by the alert notification command is displayed on the digital license plate.

In certain embodiments, the digital license plate 100 may be integrated within commercial or governmental fleets. Each digital license plate 100 operates as a node in a managed mesh-network domain, enabling fleet managers or authorized agencies to transmit or receive alert notices, compliance updates, or enforcement messages through the same mesh-network infrastructure. This architecture provides an extensible framework applicable to both consumer and enterprise vehicular ecosystems.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims.

What is claimed is:

1. A digital license plate comprising:
a display configured to display notices based on notification commands;
a cellular modem configured to communicate with a server through a communications network to receive notification commands from the server;
a chipset coupled to the cellular modem and configured to:
communicate with a user device through a mesh network, and
responsive to receipt of an alert notice from the user device through the mesh network, cause the cellular modem to establish a communication session with the server through the communications network, during which the cellular modem receives an alert notification command associated with the alert notice, wherein the establishment of the communication session occurs within an expediated communication time window; and
a processor coupled to the cellular modem and the display, the processor configured to:
process the alert notification command received through the cellular modem, and
cause the display to display a notice.

2. The digital license plate of claim 1, wherein the expediated communication time window is in a range of 1 to 45 minutes.

3. The digital license plate of claim 1, wherein:
the processor is configured to periodically cause the cellular modem to establish a scheduled communication session with the server; and
the cellular modem is configured to receive a non-alert notification command from the server during the scheduled communication session.

4. The digital license plate of claim 3, wherein the processor is configured to:
process the non-alert notification command received through the cellular modem, and
cause the display to display a notice.

5. A method comprising:
receiving, at a digital license plate, an alert notice transmitted by a user device through a mesh network;
responsive to receipt of the alert notice, causing a cellular modem of the digital license plate to establish a communication session with a server through a communications network;
receiving, during the communication session and through the cellular modem of the digital license plate, an alert notification command transmitted by the server;
processing, at the digital license plate, the alert notification command; and
displaying, at the digital license plate, a notice provided by the alert notification command.

6. The method of claim 5, wherein the establishment of communication and receipt of the alert notice occur within an expediated communication time window.

7. An alert notification system comprising:
a server; and
a digital license plate comprising:
a display configured to display notices based on notification commands;
a cellular modem configured to communicate with the server through a communications network to receive notification commands from the server;
a chipset coupled to the cellular modem and configured to:
communicate through a mesh network, and
responsive to receipt of an alert notice through the mesh network, cause the cellular modem to establish a communication session with the server through the communications network during which the cellular modem receives an alert notification command associated with the alert notice, wherein the establishment of the communication session occurs within an expediated communication time window; and
a processor coupled to the cellular modem and the display, the processor configured to:
process the alert notification command received through the cellular modem, and
cause the display to display a notice.

8. The alert notification system of claim 7, further comprising a user device configured to:
transmit a signal to establish communication with the digital license plate over the mesh network; and
upon establishment of communication, transmit the alert notice to the digital license plate over the mesh network.

9. The alert notification system of claim 7, further comprising a plurality of additional digital license plates, wherein the digital license plate and the additional digital license plates are configured to exchange authorized alert notices within a mesh-network domain.

10. The alert notification system of claim 9, wherein the digital license plate and the additional digital license plates are registered to a managed fleet account.

11. The alert notification system of claim 9, wherein the authorized alert notices comprise compliance, enforcement, or status updates for governmental or commercial entities.

12. The alert notification system of claim 9, wherein the additional digital license plates are configured the same as the digital license plate.
